(19) United States
(12) Patent Application Publication
(10) Pub. No.: US 2024/0333655 A1
(43) Pub. Date: Oct. 3, 2024

(54) FAIR AND PERFORMANT ARBITRATION IN A ROUTING COMPONENT

(71) Applicant: Meta Platforms Technologies, LLC, Menlo Park, CA (US)

(72) Inventors: Linda Cheng, San Jose, CA (US); Feng Wei, San Jose, CA (US)

(21) Appl. No.: 18/191,561

(22) Filed: Mar. 28, 2023

(51) Int. Cl. H04L 47/62

(52) U.S. Cl. CPC H04L 47/6245; H04L 47/623

(57) ABSTRACT

In one embodiment, a method by a routing component includes receiving a packet to be forwarded to a neighboring routing component, the packet being predicted to be further forwarded to a plurality of destinations from the neighboring routing component, storing the packet to a FIFO queue, determining to transmit the packet to the neighboring routing component for one or more destinations by using an arbiter associated with a transmission port connected to the neighboring routing component, determining that the plurality of destinations comprise one or more remaining destinations in addition to the one or more destinations, reading without popping the packet from the FIFO queue, and transmitting the packet to the neighboring routing component through the transmission port.

### TECHNICAL FIELD

This disclosure generally relates to computing hardware systems, and in particular, related to scheduling packet transmissions on a routing component.

### BACKGROUND

An Arbiter in a computing system may be used to provide access of hardware resources when a plurality of requesters are competing for the hardware resources. For example, a System-on-Chip (SoC) may compromise various hardware units on a single chip. In SoC, data transfer between different units may take place via single bus. The bus may need to be assigned to a single hardware unit at a particular time to remove ambiguity while a plurality of hardware units are competing for the data bus. The plurality of hardware units may be referred to as requesters. The bus may be an example of hardware resources.

A network on a chip or network-on-chip (NoC) is a network-based communications subsystem on an integrated circuit (IC), most typically between modules in a system on a chip (SoC). The modules on the IC may be semiconductor IP cores schematizing various functions of the computer system. The NoC may be a router-based packet switching network between SoC modules. A particular NoC may be a mesh communication grid which connects the majority of components within the SoC using router components.

### SUMMARY OF PARTICULAR EMBODIMENTS

Particular embodiments described herein relate to systems and methods for fair and performant arbitrations for multicast packets when unicast packets and multicast packets coexist in a credit-based network system. Problems may occur when unicast and multicast traffic are mixed in credit-based systems. The multicast packets may experience unfair arbitration when credits are sparsely issued. A solution is proposed herein to resolve the issue. With the proposed solution, the arbiter may be allowed to grant a queue to transmit a multicast packet even when the credits for only a subset of the predicted destinations are available. The proposed solution may result in a multicast packet to be read from the queue and to be transmitted through a transmission port between one and k time, where k is a number of predicted destinations for the multicast packet from the second routing component.

In particular embodiments, a first routing component may receive a packet to be forwarded to a second routing component. Receiving the packet may be through a receiving port of the first routing component that is connected to one of a plurality of sources. The packet may be predicted to be further forwarded to a plurality of destinations from the second routing component. The first routing component may store the packet to a First-In-First-Out (FIFO) queue. The FIFO queue may correspond to the one of the plurality of sources. Information regarding the plurality of destinations may be stored on a prediction array associated with the packet. Each element of the prediction array may correspond to a destination among all possible destinations from the second routing component. The first routing component may determine to transmit the packet to the second routing component for one or more destinations by using an arbiter associated with a transmission port connected to the second routing component. To determine to transmit the packet, the first routing component may receive credits for the one or more destinations from the second routing component. The credits for the one or more destinations may indicate that the second routing component has a corresponding amount of queue space on one or more transmission ports connected to the one or more destination. The credits may be greater or equal to a number of credits to transmit the packet. The first routing component may perform an arbitration among a plurality of FIFO queues corresponding to the plurality of sources for a transmission opportunity of a packet with the received credits. The first routing component may determine to transmit the packet as a result of the arbitration. The first routing component may determine that the plurality of destinations comprise one or more remaining destinations in addition to the one or more destinations. To make the determination, the first routing component may construct a credit array indicating that the one or more destinations have enough credits for the packet. Each element of the credit array may correspond to a destination among all the possible destinations from the second routing component. The first routing component may update the prediction array by subtracting the credit array from the prediction array. The first routing component may determine that the updated prediction array is not empty. The one or more remaining destinations may be represented by the updated prediction array. In response to the determination, the first routing component may read without popping the packet from the FIFO queue. Reading without popping may comprise setting a value of a shadow read pointer to a value of a read pointer of the FIFO queue, repeatedly reading a chunk from the FIFO queue by incrementing the value of the shadow read pointer until the entire packet is read and rewinding the value of the shadow read pointer to the value of the read pointer. The first routing component may modify a field of the packet indicating destinations of the packet with information about the one or more destinations. The first routing component may transmit the packet to the second routing component through the transmission port.

After transmitting the packet, the first routing component may further determine to transmit the packet to the second routing component for the one or more remaining destinations. The first routing component may determine that destinations indicated by the prediction array are identical to the one or more remaining destinations. In response to the determination, the first routing component may read with popping the packet from the FIFO queue. The first routing component may transmit the packet to the second routing component through the transmission port connected to the second component.

In particular embodiments, another possible livelock/starvation scenario may arise when a round robin arbiter is used in a credit-based system. Particular embodiments described herein relate to systems and methods for fair and performant arbitrations with utilizing masks corresponding to N indexed queues to resolve the livelock/starvation issues. A mask for each of N indexed queue may be used to keep track of whether a corresponding queue has been granted since the masks were reset. The mask may only be applied when at least one unmasked queue has something to send and also has enough credit. The mask may be reset when all the queues having packets to send have been granted once. An arbiter associated with a routing component may initialize masks corresponding to N indexed queues to a value indicating ON. The N indexed queues may attempt to transmit packets through a transmission port connected to a neighboring routing component. Each of the packets may be predicted to be further forwarded to one or more destinations from the neighboring routing component. A mask corresponding to a queue may be set to a value indicating OFF when the queue transmits a packet. The neighboring routing component may issue credits for a destination when a corresponding mount of queue space becomes available on a transmission port of the neighboring routing component that is connected to the destination. At each cycle, the arbiter may receive an arbitration request for transmitting a packet from a queue when (1) the packet is at a head of the queue and (2) the neighboring routing component has issued enough credits for at least one of the one or more destinations associated with the packet. The arbiter may repeatedly grant an opportunity for transmitting a packet to one of the N indexed queues that satisfies conditions in a round robin manner until the arbiter determines that all the masks have values indicating OFF. For granting an opportunity for transmitting a packet to one of the N indexed queues that satisfies conditions in a round robin manner, the arbiter may repeat updating a current index value and determining whether a queue corresponding to the current index value satisfies the conditions until a queue corresponding to the current index value satisfies the conditions. Updating the current index value may comprise increasing the current index value by one. When the arbiter determines that the current index value is greater than an index value corresponding to a last indexed queue among the N indexed queues, the arbiter may reset the current index value to an index value corresponding to a first indexed queue among the N indexed queues. The conditions may comprise an active request from the queue is received. The conditions may further comprise (1) the mask corresponding to the queue has a value indicating on, or (2) no other queue has an active request at the given cycle. In response to the determination that all the masks have values indicating OFF, the arbiter may reset the masks corresponding to N indexed queues. In particular embodiments, resetting the masks corresponding to N indexed queues may comprise setting the masks corresponding to N indexed queues with a value indicating on. In particular embodiments, resetting the masks corresponding to N indexed queues may comprise setting the masks corresponding to N indexed queues except a current queue with a value indicating on.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example architecture of an NoC.

FIG. 2A illustrates example unicast packet routings between routing components in an NoC.

FIG. 2B illustrates an example routing of a multicast packet in an NoC.

FIG. 2C illustrates an example situation for issuing credits in a credit-based NoC.

FIG. 3 illustrates an example situation where a queue experiences a starvation.

FIG. 4 illustrates an example reading without popping from a FIFO queue.

FIG. 5 illustrates an example method for fair and performant arbitrations for multicast packets when unicast packets and multicast packets coexist in a credit-based network system.

FIG. 6 illustrates an example scenario where livelocks/starvations occur on a number of queues when a round robin arbiter is used in a credit-based system.

FIG. 7 illustrates an example scenario where masks are utilized for fair arbitrations in a credit-based system.

FIG. 8 illustrates an example method for fair and performant arbitrations using masks corresponding to N indexed queues in a credit-based network system.

FIG. 9 illustrates an example computer system.

### DESCRIPTION OF EXAMPLE EMBODIMENTS

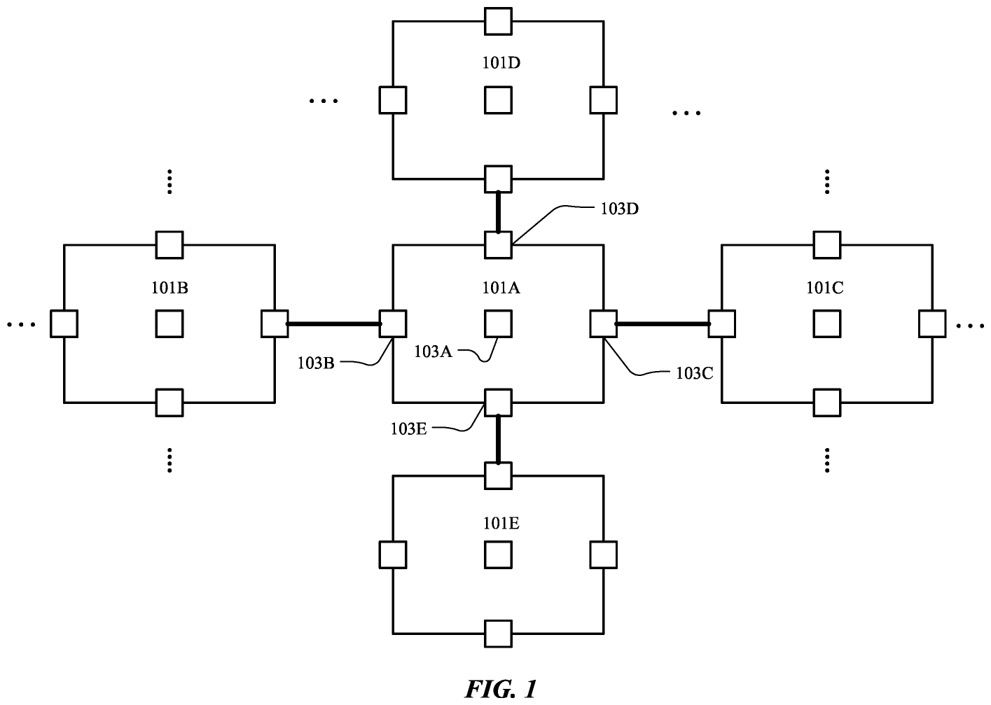

FIG. 1 illustrates an example architecture of an NoC. Routing components 101A. 101B, 101C, 101D, and 101E are connected with each other in a grid manner. While FIG. 1 shows only five routing components, a lot more routing components may exist in the NoC. A packet from a source module to a destination module may be routed through a plurality of routing components. In the example illustrated in FIG. 1, a routing component 101A may have five communication ports. While a communication port is shown as a single hardware element in FIG. 1, the communication port may comprise a reception port and a transmission port. A first communication port 103A may be connected to a local module associated with the routing component 101A. The local port 103A may be referred to as a fabric interface (FI). A second communication port 103B may be connected to the routing component 101B. A third communication port 103C may be connected to the routing component 101C. A fourth communication port 103D may be connected to the routing component 101D. A fifth communication port 103E may be connected to the routing component 101E. Although this disclosure describes a particular logical architecture of an NoC. this disclosure contemplates any suitable logical architecture of an NoC.

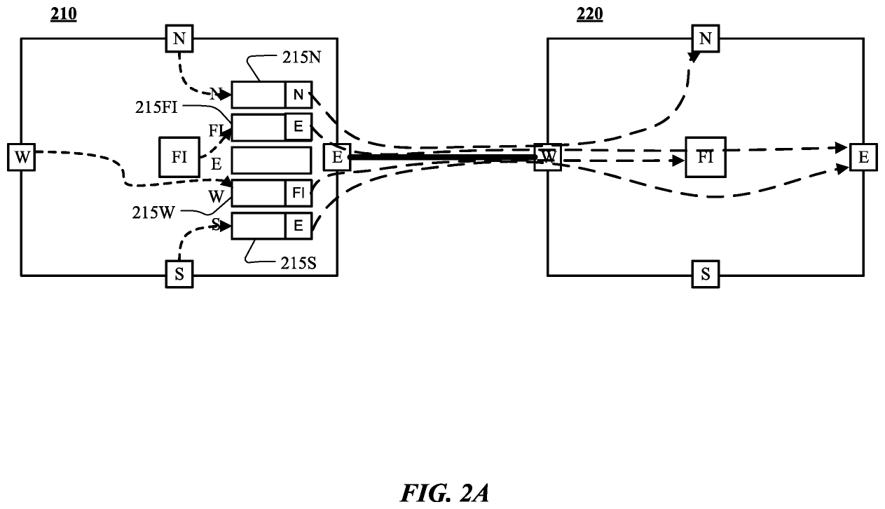

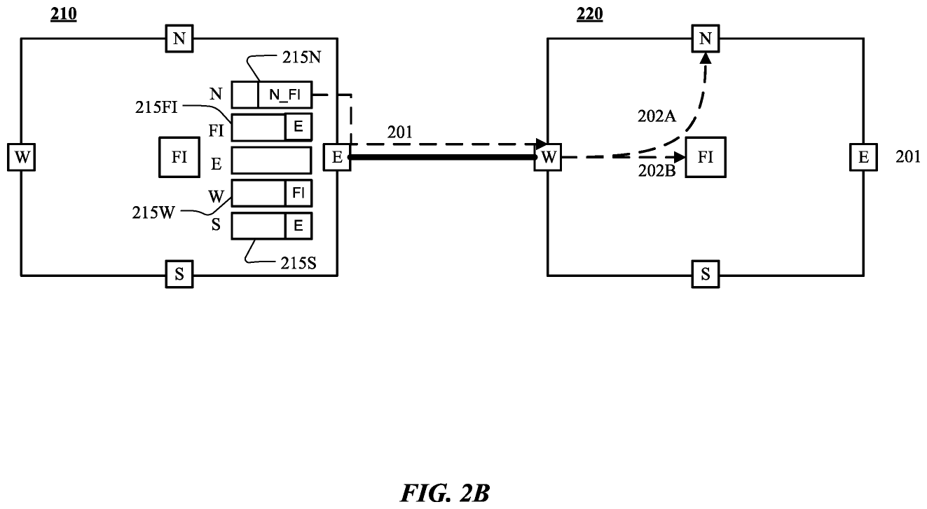

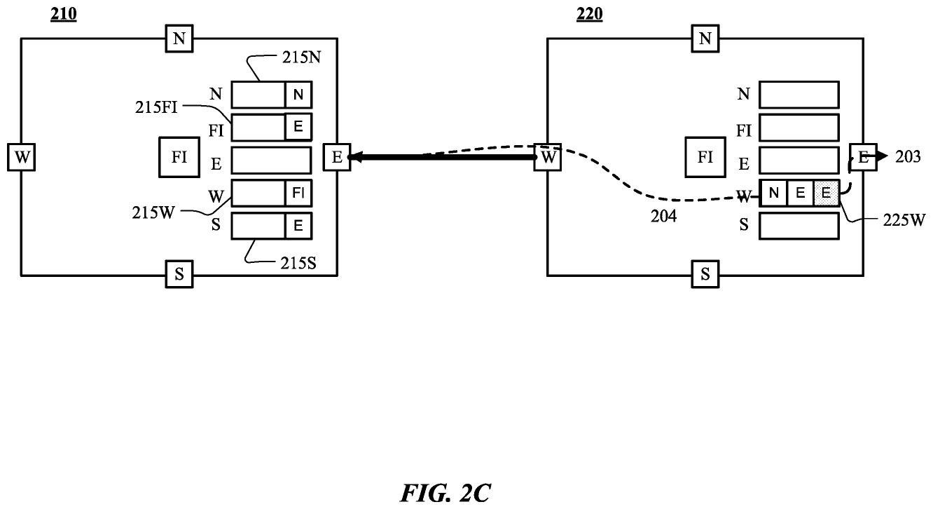

FIG. 2A illustrates example unicast packet routings between routing components in an NoC. Two routing components 210 and 220 are connected to each other. An East transmission port of the first routing component 210 may be connected to the second routing component 220. The East transmission port of the first routing component 210 may be associated with five queues 215N, 215FI, 215E, 215W, and 215S as the first routing component 210 may have five communication ports, each may comprise a reception port and a transmission port. A first queue 215N may have packets that are received through a North reception port and are to be forwarded toward the second routing component 220 through the East transmission port. A second queue 215FI may have packets that are received through a FI reception port and are to be forwarded toward the second routing component 220 through the East transmission port. A third queue 215E should be empty all the time as transmitting a packet received from East back to East is not allowed. A fourth queue 215W may have packets that are received through a West reception port and are to be forwarded toward the second routing component 220 through the East transmission port. A fifth queue 215S may have packets that are received through a South reception port and are to be forwarded toward the second routing component 220 through the East transmission port. Each packet may be predicted to be further forwarded to one or more destinations from the second routing component 220. In the example illustrated in FIG. 2A, the first queue 215N has a packet predicted to be forwarded to North from the second routing component 220. When this packet is received through the West reception port of the second routing component 220, the second routing component 220 may internally forward the packet to a West queue associated with its North transmission port. The second queue 215FI has a packet predicted to be forwarded to East from the second routing component 220. When this packet is received through the West reception port of the second routing component 220, the second routing component 220 may internally forward the packet to a West queue associated with its East transmission port. The fourth queue 215W has a packet predicted to be forwarded to FI from the second routing component 220. When this packet is received through the West reception port of the second routing component 220, the second routing component 220 may internally forward the packet to a West queue associated with its FI transmission port. The fifth queue 215S has a packet predicted to be forwarded to East from the second routing component 220. When this packet is received through the West reception port of the second routing component 220, the second routing component 220 may internally forward the packet to a West queue associated with its East transmission port. Each packet may be transmitted through the East transmission port toward the second routing component 220 when the corresponding queue wins a transmission opportunity through an arbitration. Although this disclosure describes routing unicast packets in a particular manner, this disclosure contemplates routing unicast packets in any suitable manner.

FIG. 2B illustrates an example routing of a multicast packet in an NoC. A multicast packet may be sent from a single source to multiple destinations. In the example illustrated in FIG. 2B, the first queue 215N has a multicast packet that is predicted to be forwarded toward North and FI from the second routing component 220. At step 201, the first routing component 210 may forward the packet to the second routing component 220 through its East transmission port. Upon receiving the packet through the West reception port, the second routing component 220 may duplicate the packet. At step 202A, the second routing component 220 may forward a first copy of the packet to the West queue associated with the North transmission port. At step 202B, the second routing component 220 may forward a second copy of the packet to the West queue associated with the FI transmission port. Although this disclosure describes routing multicast packets in a particular manner, this disclosure contemplates routing multicast packets in any suitable manner.

FIG. 2C illustrates an example situation for issuing credits in a credit-based NoC. In the example illustrated in FIG. 2C, a West queue 225W associated with the East transmission port of the second routing component 220 is full. The second routing component 220 has already reported to the first routing component 210 that credit associated with its East transmission port is exhausted. An arbiter associated with the East transmission port on the first routing component 210 may not grant a transmission opportunity to the second queue 215FI or the fifth queue 215S because the packets at the head of those queues are predicted to be forwarded to East from the second routing component 220. At step 203, the second routing component 220 sends a first packet from the West queue 225W associated with its East transmission port. After second the packet, the West queue 225W associated with the East transmission port has available space. At step 204, the second routing component 220 may send a signaling message to the first routing component 210 for issuing East transmission credit corresponding to the amount of the available space. On receiving the signaling message, the arbiter associated with the East transmission port on the first routing component 210 may grant a transmission opportunity to either the second queue 215FI or the fifth queue 215S as the East transmission port on the second routing component 220 has enough credit for a packet. Although this disclosure describes issuing credit corresponding to an amount of space available at a queue in a particular manner, this disclosure contemplates issuing credit corresponding to an amount of space available at a queue in any suitable manner.

### Fair and Performant Arbitration for a Mix of Unicast and Multicast Packets in a Credit-Based System

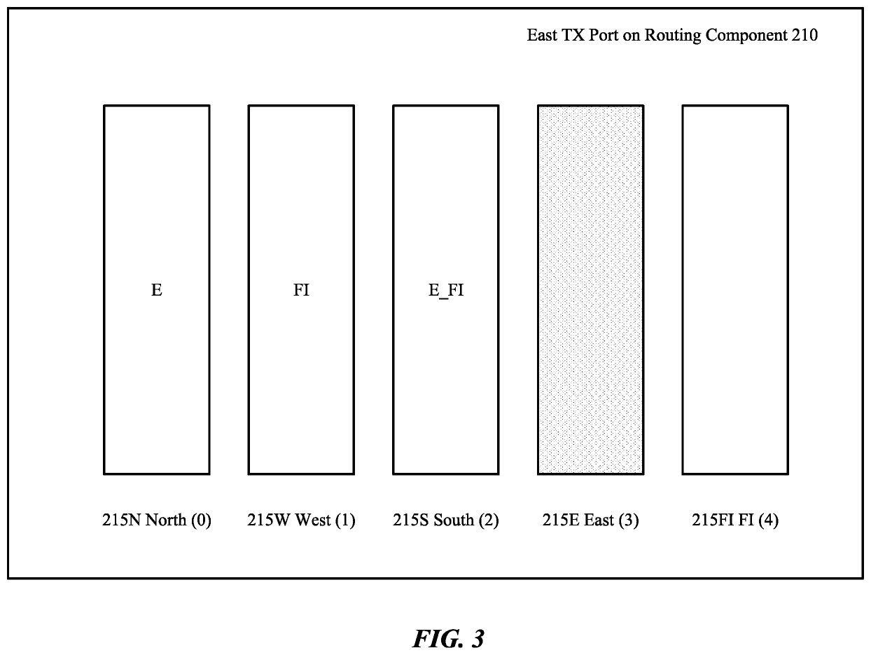

In particular embodiments, problems may occur when unicast and multicast traffic are mixed in credit-based systems. The multicast packets may experience unfair arbitration when credits are sparsely issued. FIG. 3 illustrates an example situation where a queue experiences a starvation/livelock. The queues 215N. 215W, 215S, 215E, and 215FI are associated with the East transmission port on the first routing component 210 that is connected to the second routing component 220. The North queue 215N has packets predicted to be forwarded to North of the second routing component 220. The West queue 215W has packets predicted to be forwarded to FI of the second routing component 220. The South queue 215S has a multicast packet predicted to be forwarded to East and FI of the second routing component 220. The arbiter associated with the East transmission port may need to check the credit associated with the predicted destinations.

The multicast packet on the South queue 215S may need credit for both East and FI transmission ports from the second routing component 220. Assume that the arbiter runs out of credit for both East and FI. As soon as one credit for the East transmission port on the second routing component 220 arrives, a packet on the North queue 215N would consume the credit. Similarly, as soon as one credit for the FI transmission port on the second routing component 220 arrives, a packet on the West queue 215W would consume the credit. Because the multicast packet on the South queue 215S needs credits for both the East transmission port and the FI transmission port of the second routing component 220, the multicast packet on the South queue 215S may not have a chance to be transmitted as long as the credits arrive one by one and the North queue 215N and the West queue 215W have packets predicted to be forwarded toward East and FI of the second routing component 220.

An intuitive approach to resolve the starvation/livelock on the multicast packet may be enqueuing a copy of the multicast packet for each predicted destination of the multicast packet. Each enqueued copy may be treated as a unicast packet. Although this approach may resolve the starvation/livelock issue, the approach may result in waste of the bandwidth between the first routing component 210 and the second routing component 220. A solution for a fair and performant arbitration for multicast packets is proposed herein, where the arbiter is allowed to grant a queue to transmit a multicast packet even when the credits for only a subset of the predicted destinations are available. The proposed solution may result in a multicast packet to be read from the queue and to be transmitted through a transmission port between one and k time, where k is a number of predicted destinations for the multicast packet from the second routing component.

In particular embodiments, a first routing component 210 may receive a packet to be forwarded to a second routing component 220. Receiving the packet may be through a receiving port of the first routing component that is connected to one of a plurality of sources. The packet may be predicted to be further forwarded to a plurality of destinations from the second routing component. As an example and not by way of limitation, continuing with a prior example illustrated in FIG. 3, the first routing component 210 may receive a multicast packet to be forwarded to the second routing component 220 through the East transmission port on the first routing component 210. The multicast packet may have been received through the South reception port. The multicast packet may be predicted to be forwarded to East and FI of the second routing component 220. Although this disclosure describes receiving a multicast packet that is to be forwarded to a neighboring routing component in a particular manner, this disclosure contemplates receiving a multicast packet that is to be forwarded to a neighboring routing component in any suitable manner.

In particular embodiments, the first routing component 210 may store the packet to a FIFO queue. The FIFO queue may correspond to the one of the plurality of sources. As an example and not by way of limitation, continuing with a prior example, the multicast packet may be stored to the South FIFO queue 215S associated with the East transmission port of the first routing component 210 as the packet was received through the South reception port. Although this disclosure describes queuing a multicast queue in a particular manner, this disclosure contemplates queuing a multicast queue in any suitable manner.

In particular embodiments, information regarding the plurality of destinations may be stored on a prediction array associated with the packet. Each element of the prediction array may correspond to a destination among all possible destinations from the second routing component. As an example and not by way of limitation, continuing with a prior example illustrated in FIG. 3, the first bit of the prediction array corresponds to North. The second bit of the prediction array corresponds to West. The third bit of the prediction array corresponds to South. The fourth bit of the prediction array corresponds to East. The fifth bit of the prediction array corresponds to FI. Then, the prediction array for the multicast packet in the South queue 215S may be ‘00011’ to indicate that the multicast packet is predicted to be forwarded to Eat and FI from the second routing component 220. Although this disclosure describes encoding destinations of a packet in a particular manner, this disclosure contemplates encoding destinations of a packet in any suitable manner.

In particular embodiments, the first routing component 210 may determine to transmit the packet to the second routing component 220 for one or more destinations by using an arbiter associated with a transmission port connected to the second routing component 220. To determine to transmit the packet, the first routing component 210 may receive credits for the one or more destinations from the second routing component 220. The credits for the one or more destinations may indicate that the second routing component 220 has a corresponding amount of queue space on one or more transmission ports connected to the one or more destination. The credits may be greater or equal to a number of credits to transmit the packet. The first routing component 210 may perform an arbitration with the received credits among a plurality of FIFO queues corresponding to the plurality of sources for a transmission opportunity of a packet. The first routing component 210 may determine to transmit the packet as a result of the arbitration. As an example and not by way of limitation, continuing with a prior example, the first routing component 210 receives credits for East transmission port from the second routing component 220. The received credits are enough for the multicast packet. The arbiter associated with the East transmission port of the first routing component 210 may grant the South queue 215S to transmit the multicast packet based on the received credit for the East transmission port of the second routing component 220. Although this disclosure describes an arbitration for a multicast packet with credits for a subset of the predicted destinations in a particular manner, this disclosure contemplates an arbitration for a multicast packet with credits for a subset of the predicted destinations in any suitable manner.

In particular embodiments, the first routing component 210 may determine that the plurality of destinations encoded in the prediction array comprise one or more remaining destinations in addition to the one or more destinations. To make the determination, the first routing component 210 may construct a credit array indicating that the one or more destinations have enough credits for the packet. Each element of the credit array may correspond to a destination among all the possible destinations from the second routing component 220. The first routing component 210 may update the prediction array by subtracting the credit array from the prediction array. The first routing component 210 may determine that the updated prediction array is not empty. The one or more remaining destinations may be represented by the updated prediction array. As an example and not by way of limitation, continuing with a prior example, the prediction array for the multicast packet on the South queue 215S has ‘00011.’ The first routing component 210 construct a credit array for the multicast packet indicating destinations with enough credit for the multicast packet. As the first routing component 210 has received credits for only East transmission port, the credit array would be encoded as ‘00010.’ The first routing component 210 updates the prediction array by subtracting the credit array ‘00010’ from the prediction array ‘00011.’ The updated prediction array ‘00001’ is not empty. Thus, the first routing component 210 determines that the multicast packet has one or more remaining destinations after being sent to be forwarded toward East from the second routing component 220. Although this disclosure describes determining whether a multicast packet has credits for all the predicted destinations in a particular manner, this disclosure contemplates determining whether a multicast packet has credits for all the predicted destinations in any suitable manner.

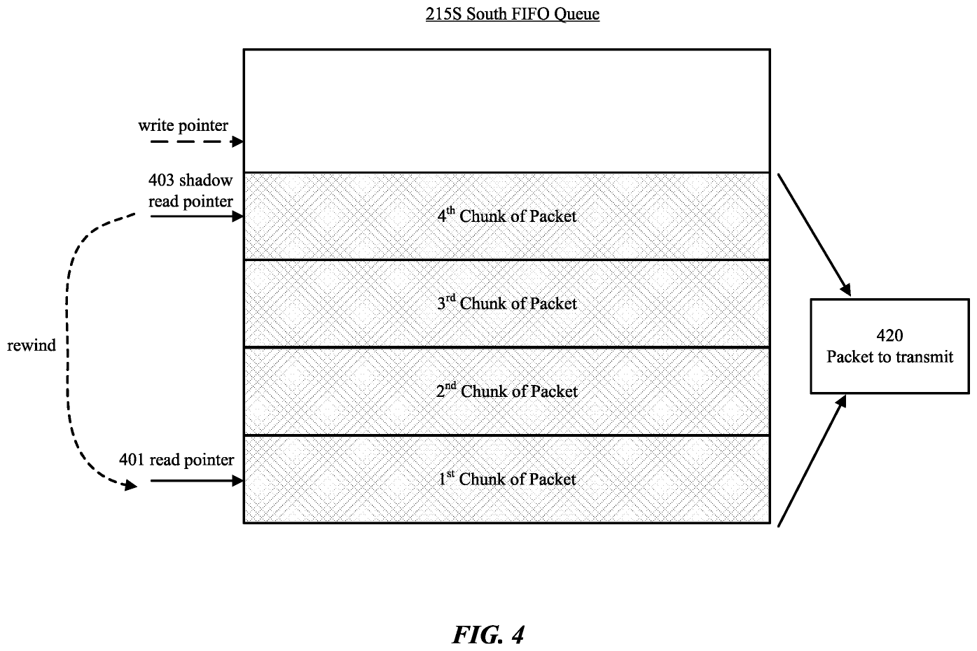

In response to the determination, the first routing component 210 may read without popping the packet from the FIFO queue. Reading without popping may comprise setting a value of a shadow read pointer to a value of a read pointer of the FIFO queue, repeatedly reading a chunk from the FIFO queue by incrementing the value of the shadow read pointer until the entire packet is read and rewinding the value of the shadow read pointer to the value of the read pointer. FIG. 4 illustrates an example reading without popping from a FIFO queue. As an example and not by way of limitation, illustrated in FIG. 4, continuing with a prior example, the first routing component 210 reads the multicast packet without popping from the South FIFO queue 215S. A read pointer 401 indicates a beginning of the multicast packet on the South FIFO queue 215S. The first routing component 210 set a value of a shadow read pointer 403 to a value of the read pointer 401. The first routing component 210 reads the multicast packet one chunk at a time by incrementing the value of the shadow read pointer 403 until the entire multicast packet is read from the South FIFO queue 215S. The read multicast packet 420 is ready to be sent through the East transmission port of the first routing component 210. When the entire packet is read from the South FIFO queue 215S, the first routing component 210 may rewind the value of the shadow read pointer 403 to the value of the read pointer 401 for a potential read without popping in the future. Although this disclosure describes reading a packet without popping from a FIFO queue in a particular manner, this disclosure contemplates reading a packet without popping from a FIFO queue in any suitable manner.

In particular embodiments, the first routing component 210 may modify a field of the packet indicating destinations of the packet with information about the one or more destinations. The first routing component 210 may transmit the packet to the second routing component 220 through the transmission port. As an example and not by way of limitation, continuing with a prior example, the first routing component 210 modifies a field of a read copy of the multicast packet to indicate that the packet is to be forwarded to East from the second routing component 220. The first routing component 210 sends the copy of the multicast packet to the second routing component 220 through the East transmission port. The second routing component 220 may receive the packet through the West reception port. Based on the field of the packet, the second routing component 220 may store the packet to the West FIFO queue 225W associated with the East transmission port of the second routing component 220. Although this disclosure describes transmitting a copy of a multicast packet for a subset of the predicted destinations in a particular manner, this disclosure contemplates transmitting a copy of a multicast packet for a subset of the predicted destinations in any suitable manner.

In particular embodiments, the first routing component 210 may determine to transmit the packet to the second routing component for the one or more remaining destinations. The first routing component 210 may determine that destinations indicated by the prediction array are identical to the one or more remaining destinations. In response to the determination, the first routing component 210 may read with popping the packet from the FIFO queue. The first routing component 210 may transmit the packet to the second routing component through the transmission port connected to the second component. As an example and not by way of limitation, continuing with a prior example, the first routing component 210 may receive credits for the FI transmission port of the second routing component 220 from the second routing component 220. The arbiter associated with the East transmission port may grant a transmission opportunity to the South queue 215S based on the received credits for the FI transmission port of the second routing component 220. The first routing component 210 determines that no remaining destination would be left after sending the multicast packet to the second routing component 220 to be forwarded to local of the second routing component 220 by subtracting a constructed credit array ‘00001’ from the prediction array ‘00001.’ The first routing component 210 may read the multicast packet with popping from the South FIFO queue 215S. After reading with popping, the read pointer 401 of the South FIFO queue 215S would advance to a beginning of a next packet. The first routing component 210 modifies the field of a read copy of the multicast packet to indicate that the packet is to be forwarded to a local module of the second routing component 220. The first routing component 210 sends the copy of the multicast packet to the second routing component 220 through the East transmission port. The second routing component 220 may receive the packet through the West reception port. Based on the field of the packet, the second routing component 220 may store the packet to a West FIFO queue associated with the FI transmission port of the second routing component 220. Although this disclosure describes transmitting a multicast packet for the remaining destinations in a particular manner, this disclosure contemplates transmitting a multicast packet for the remaining destinations in any suitable manner.

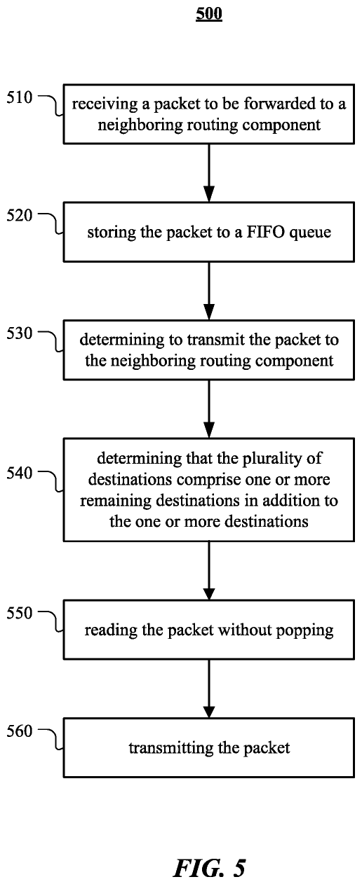

FIG. 5 illustrates an example method 500 for fair and performant arbitrations for multicast packets when unicast packets and multicast packets coexist in a credit-based network system. The method may begin at step 510, where a routing component of a network may receive a packet to be forwarded to a neighboring routing component. The packet may be predicted to be further forwarded to a plurality of destinations from the neighboring routing component. At step 520, the routing component may store the packet to a FIFO queue. Information regarding the plurality of destinations may be stored on a prediction array associated with the packet. At step 530, the routing component may determine to transmit the packet to the neighboring routing component for one or more destinations by using an arbiter associated with a transmission port connected to the neighboring routing component. At step 540, the routing component may determine that the plurality of destinations comprise one or more remaining destinations in addition to the one or more destinations. At step 550, the routing component may read without popping the packet from the FIFO queue in response to the determination. At step 560, the routing component may transmit the packet to the neighboring routing component through the transmission port. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for fair and performant arbitrations for multicast packets when unicast packets and multicast packets coexist in a credit-based network system including the particular steps of the method of FIG. 5, this disclosure contemplates any suitable method for fair and performant arbitrations for multicast packets when unicast packets and multicast packets coexist in a credit-based network system including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Fair and Performant Arbitration in a Credit-Based System

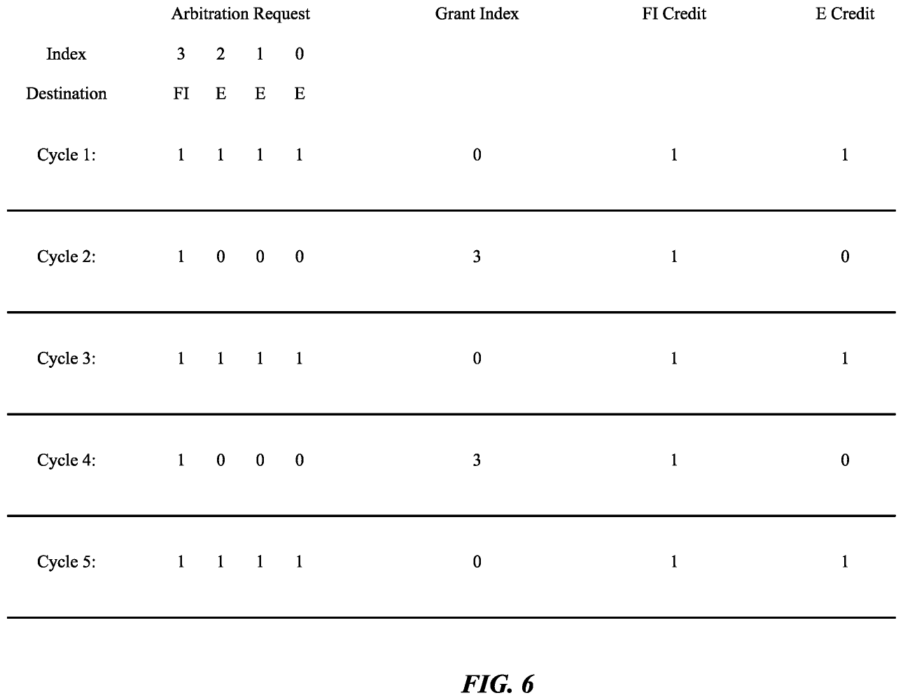

In particular embodiments, another possible livelock/starvation scenario may arise when a round robin arbiter is used in a credit-based system. FIG. 6 illustrates an example scenario where livelocks/starvations occur on a number of queues when a round robin arbiter is used in a credit-based system. in the example illustrated in FIG. 6, four queues, indexed 0, 1, 2, and 3, are associated with a transmission port on a first routing component 210. A round robin arbiter may go through the queues until the arbiter finds a queue that satisfies conditions to send a packet port to the second routing component 220 through the transmission. The conditions may comprise that the arbiter has credit for a transmission port on the second routing component 220 enough for a packet at the head of the queue. When a current index value for the round robin goes beyond the last index among the competing queues, the current index value may be wrapped around to an index value for the first index among the competing queues. In the example illustrated in FIG. 6, three queues indexed 0, 1, and 2 have packets predicted to be forwarded to East from the second routing component 220, while a queue indexed 3 has packets predicted to be forwarded to a local module of the second routing component 220 through a FI transmission port. As the East transmission port of the second routing component 220 is busy, credits for the East transmission port arrive sparsely while plenty credits for the FI transmission port are available. At cycle 1, the arbiter grants queue with index 0 a transmission opportunity as a credit for the East transmission port from the second routing component is available. After transmitting a packet from the queue with index 0, no further credit for the East transmission port is available. At cycle 2, the arbiter goes through queues with index 1 and 2 but finds that those queues do not have active arbitration request because the credit for the East transmission port is empty. The arbiter grants the queue with index 3 a transmission opportunity because enough credits are available for the FI transmission port. At cycle 3, a credit for the East transmission port becomes available. The arbiter grants the queue with index 0 a transmission opportunity. At cycle 4, the credit for the East transmission port is empty. Thus, the arbiter skips the queues with index 1 and 2 and grants the queue with index 3 a transmission opportunity. At cycle 5, a credit for the East transmission port becomes available. The arbiter grants the queue with index 0 a transmission opportunity. Like this, the queues with indices 1 and 2 do not get chances to transmit their packets when a simple round robin arbiter is used in a credit-based system.

In order to resolve the livelock/starvation issues, a solution is proposed herein that utilizes a mask for each of N indexed queue to keep track of whether a corresponding queue has been granted since the masks were reset. The mask may only be applied when at least one unmasked queue has something to send and also has enough credit. The mask may be reset when all the queues having packets to send have been granted once.

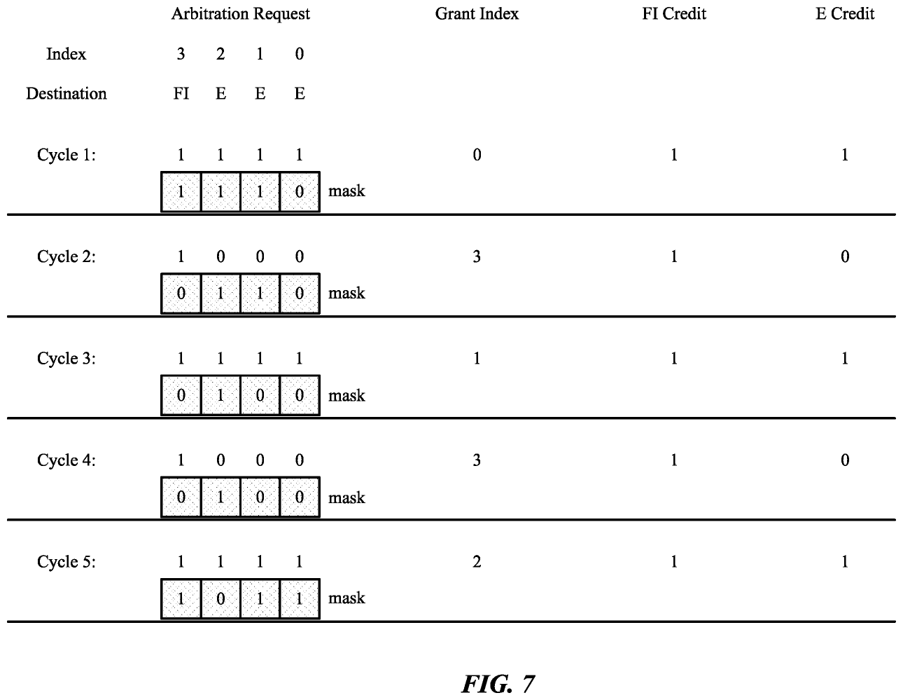

FIG. 7 illustrates an example scenario where masks are utilized for fair arbitrations in a credit-based system. In particular embodiments, an arbiter associated with a routing component may initialize masks corresponding to N indexed queues to a value indicating ON. The N indexed queues may attempt to transmit packets through a transmission port connected to a neighboring routing component. Each of the packets may be predicted to be further forwarded to one or more destinations from the neighboring routing component. As an example and not by way of limitation, illustrated in FIG. 7, the arbiter initializes the masks for queues with index 0, 1, 2, and 3 with 1 before cycle 1. The queue with index 0 has packets predicted to be forwarded to East on the second routing component. The queue with index 1 has packets predicted to be forwarded to East on the second routing component. The queue with index 2 has packets predicted to be forwarded to East on the second routing component. The queue with index 3 has packets predicted to be forwarded to a local module associated with the second routing component through the FI transmission port of the second routing component. Although this disclosure describes initializing masks corresponding to N indexed queues in a particular manner, this disclosure contemplates initializing masks corresponding to N indexed queues in any suitable manner.

In particular embodiments, the neighboring routing component may issue credits for a destination when a corresponding mount of queue space becomes available on a transmission port of the neighboring routing component that is connected to the destination. At each cycle, the arbiter may receive an arbitration request for transmitting a packet from a queue when (1) the packet is at a head of the queue and (2) the neighboring routing component has issued enough credits for at least one of the one or more destinations associated with the packet. As an example and not by way of limitation, the second routing component issues a credit for the East transmission port and issues plenty credits for the FI transmission port before cycle 1. Thus, the arbiter receives arbitration requests from all the queues because enough credits exist for packets at the head of all the queues. As another example and not by way of limitation, in cycle 2, the arbiter receives an arbitration request from only queue with index 3 because the credit for the East transmission port at the second routing component is empty at cycle 2. Although this disclosure describes receiving an arbitration request for transmitting a packet from a queue when (1) the packet is at a head of the queue and (2) the neighboring routing component has issued enough credits for at least one of the one or more destinations associated with the packet in a particular manner, this disclosure contemplates receiving an arbitration request for transmitting a packet from a queue when (1) the packet is at a head of the queue and (2) the neighboring routing component has issued enough credits for at least one of the one or more destinations associated with the packet in any suitable manner.

In particular embodiments, a mask corresponding to a queue may be set to a value indicating OFF when the queue transmits a packet. As an example and not by way of limitation, at cycle 1, the arbiter grants the queue with index 0 a transmission opportunity. After the queue with index 0 transmits a packet, the mask corresponding to the queue with index 0 is set to 0. Although this disclosure describes changing a value of a mask when a corresponding queue transmits a packet in a particular manner, this disclosure contemplates changing a value of a mask when a corresponding queue transmits a packet in any suitable manner.

In particular embodiments, the arbiter may repeatedly grant an opportunity for transmitting a packet to one of the N indexed queues that satisfies conditions in a round robin manner until the arbiter determines that all the masks have values indicating OFF. For granting an opportunity for transmitting a packet to one of the N indexed queues that satisfies conditions in a round robin manner, the arbiter may repeat updating a current index value and determining whether a queue corresponding to the current index value satisfies the conditions until a queue corresponding to the current index value satisfies the conditions. Updating the current index value may comprise increasing the current index value by one. When the arbiter determines that the current index value is greater than an index value corresponding to a last indexed queue among the N indexed queues, the arbiter may reset the current index value to an index value corresponding to a first indexed queue among the N indexed queues. The conditions may comprise an active request from the queue is received. The conditions may further comprise (1) the mask corresponding to the queue has a value indicating on, or (2) no other queue has an active request at the given cycle. As an example and not by way of limitation, in cycle 2, the arbiter skips queues with index 1 and 2 because those queues do not have active request due to lack of credit. The arbiter grants the queue with index 3 a transmission opportunity in cycle 2 because the queue with index 3 has an active arbitration request and the corresponding mask value of 1. The mask value is set to 0 after the queue with index 3 transmit a packet. As another example and not by way of limitation, the arbiter skips the queue with index 0 in cycle 3 because the value of the corresponding mask is 0. The arbiter grants a transmission opportunity to the queue with index 1 in cycle 3. The mask corresponding to the queue with index 1 is set to 0. As yet another example and not by way of limitation, the arbiter grants a transmission opportunity to the queue with index 3 in cycle 4 even though the corresponding mask value is 0 because none of the other queues has an active arbitration request due to lack of credit for the East transmission port from the second routing component. Although this disclosure describes granting an opportunity for transmitting a packet to one of the N indexed queues that satisfies conditions in a particular manner, this disclosure contemplates granting an opportunity for transmitting a packet to one of the N indexed queues that satisfies conditions in any suitable manner.

In particular embodiments, the arbiter may reset the masks corresponding to N indexed queues in response to the determination that all the masks have values indicating OFF. In particular embodiments, resetting the masks corresponding to N indexed queues may comprise setting the masks corresponding to N indexed queues except a current queue with a value indicating ON. In particular embodiments, resetting the masks corresponding to N indexed queues may comprise setting the masks corresponding to N indexed queues with a value indicating ON. As an example and not by way of limitation, in cycle 5, the arbiter grants a transmission opportunity to the queue with index 2 because the queue with index 2 is the only queue with the mask value 1. After transmitting a packet at the head of the queue with index 2, the arbiter set the value of the corresponding mask to 0. The arbiter determines that all the masks have values zero. Thus, the arbiter resets the masks corresponding to the queues. In the example illustrated in FIG. 7, the resetting the masks comprises setting the masks corresponding to the queues except the mask corresponding to the queue with index 2 to 1. Alternatively, the resetting the masks may comprise setting the values of the masks corresponding to all the queues to 1. Although this disclosure describes reset the masks corresponding to N indexed queues in a particular manner, this disclosure contemplates reset the masks corresponding to N indexed queues in any suitable manner.

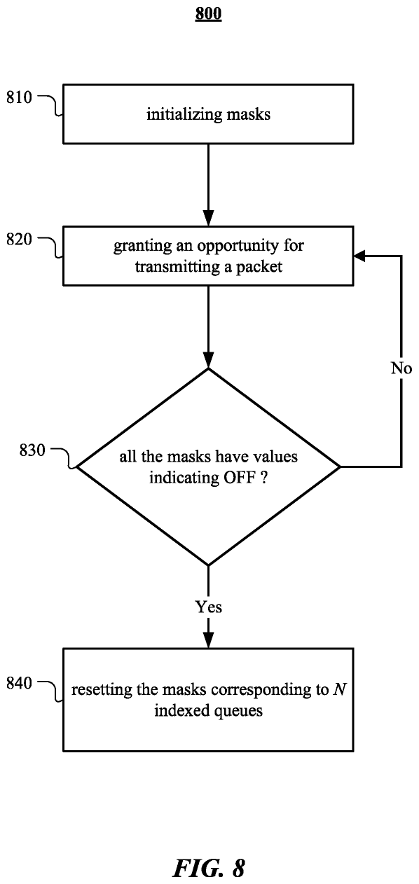

FIG. 8 illustrates an example method 800 for fair and performant arbitrations using masks corresponding to N indexed queues in a credit-based network system. The method may begin at step 810, where an arbiter associated with a routing component may initialize masks corresponding to N indexed queues to a value indicating ON. The N indexed queues may attempt to transmit packets through a transmission port connected to a neighboring routing component. Each of the packets may be predicted to be further forwarded to one or more destinations from the neighboring routing component. A mask corresponding to a queue may be set to a value indicating OFF when the queue transmits a packet. At step 820, the arbiter may grant an opportunity for transmitting a packet to one of the N indexed queues that satisfies conditions in a round robin manner. At step 830, the arbiter may determine whether all the masks have values indicating OFF. If not, the arbiter may go back to step 820. At step 840, the arbiter may reset the masks corresponding to N indexed queues in response to the determination that all the masks have values indicating OFF. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for fair and performant arbitrations using masks corresponding to N indexed queues in a credit-based network system including the particular steps of the method of FIG. 8, this disclosure contemplates any suitable method for fair and performant arbitrations using masks corresponding to N indexed queues in a credit-based network system including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

Systems and Methods

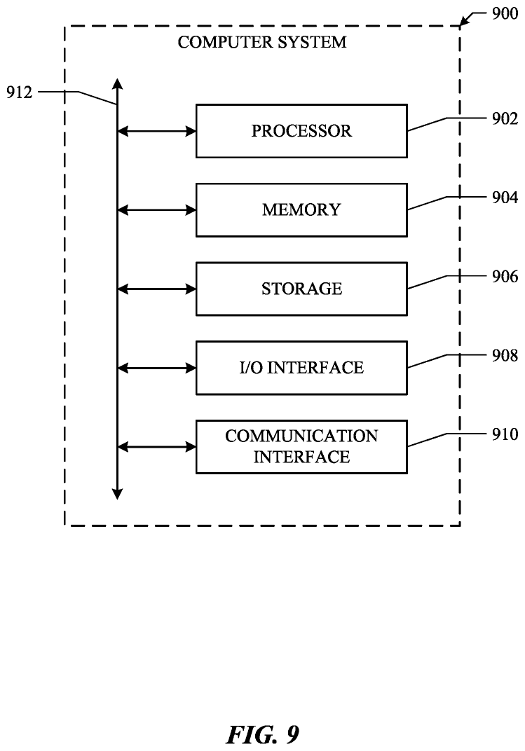

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed;

span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation. bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a routing component of a network:
receiving a packet to be forwarded to a neighboring routing component, wherein the packet is predicted to be further forwarded to a plurality of destinations from the neighboring routing component;
storing the packet to a First-In-First-Out (FIFO) queue, wherein information regarding the plurality of destinations is stored on a prediction array associated with the packet;
determining, by using an arbiter associated with a transmission port connected to the neighboring routing component, to transmit the packet to the neighboring routing component for one or more destinations;
determining that the plurality of destinations comprise one or more remaining destinations in addition to the one or more destinations;
reading without popping, in response to the determination, the packet from the FIFO queue; and
transmitting the packet to the neighboring routing component through the transmission port.

2. The method of claim 1, wherein receiving the packet is through a receiving port of the routing component that is connected to one of a plurality of sources.

3. The method of claim 2, wherein the FIFO queue corresponds to the one of the plurality of sources.

4. The method of claim 3, wherein determining to transmit the packet comprises:
receiving, from the neighboring routing component, credits for the one or more destinations, wherein the credits are greater or equal to a number of credits to transmit the packet;
performing, with the received credits, an arbitration among a plurality of FIFO queues corresponding to the plurality of sources for a transmission opportunity of a packet; and
determining to transmit the packet as a result of the arbitration.

5. The method of claim 4, wherein the credits for the one or more destinations indicate that the neighboring routing component has a corresponding amount of queue space on one or more transmission ports connected to the one or more destination.

6. The method of claim 1, wherein each element of the prediction array corresponds to a destination among all possible destinations from the neighboring routing component.

7. The method of claim 6, wherein determining that the plurality of destinations comprise one or more remaining destinations in addition to the one or more destinations comprises:
constructing a credit array indicating that the one or more destinations have enough credits for the packet, wherein each element of the credit array corresponds to a destination among all the possible destinations from the neighboring routing component;
updating the prediction array by subtracting the credit array from the prediction array; and
determining that the updated prediction array is not empty, wherein the one or more remaining destinations are represented by the updated prediction array.

8. The method of claim 1, wherein reading without popping comprises:
setting a value of a shadow read pointer to a value of a read pointer of the FIFO queue;
repeatedly reading a chunk from the FIFO queue by incrementing the value of the shadow read pointer until the entire packet is read; and
rewinding the value of the shadow read pointer to the value of the read pointer.

9. The method of claim 1, transmitting the packet comprises modifying a field of the packet indicating destinations of the packet with information about the one or more destinations.

10. The method of claim 1 further comprising:
determining, using the arbiter, to transmit the packet to the neighboring routing component for the one or more remaining destinations;
determining that destinations indicated by the prediction array are identical to the one or more remaining destinations;
reading with popping, in response to the determination, the packet from the FIFO queue; and
transmitting the packet to the neighboring routing component through the transmission port.

11. One or more computer-readable non-transitory storage media embodying software that is operable when executed, by a routing component of a network, to:
receive a packet to be forwarded to a neighboring routing component, wherein the packet is predicted to be further forwarded to a plurality of destinations from the neighboring routing component;
store the packet to a First-In-First-Out (FIFO) queue, wherein information regarding the plurality of destinations is stored on a prediction array associated with the packet;
determine, by using an arbiter associated with a transmission port connected to the neighboring routing component, to transmit the packet to the neighboring routing component for one or more destinations;
determine that the plurality of destinations comprise one or more remaining destinations in addition to the one or more destinations;
read without popping, in response to the determination, the packet from the FIFO queue; and
transmit the packet to the neighboring routing component through the transmission port.

12. The media of claim 11, wherein receiving the packet is through a receiving port of the routing component that is connected to one of a plurality of sources.

13. The media of claim 12, wherein the FIFO queue corresponds to the one of the plurality of sources.

14. The media of claim 13, wherein determining to transmit the packet comprises:
receiving, from the neighboring routing component, credits for the one or more destinations, wherein the credits are greater or equal to a number of credits to transmit the packet;
performing, with the received credits, an arbitration among a plurality of FIFO queues corresponding to the plurality of sources for a transmission opportunity of a packet; and
determining to transmit the packet as a result of the arbitration.

15. The media of claim 14, wherein the credits for the one or more destinations indicate that the neighboring routing component has a corresponding amount of queue space on one or more transmission ports connected to the one or more destination.

16. The media of claim 11, wherein each element of the prediction array corresponds to a destination among all possible destinations from the neighboring routing component.

17. The media of claim 16, wherein determining that the plurality of destinations comprise one or more remaining destinations in addition to the one or more destinations comprises:
constructing a credit array indicating that the one or more destinations have enough credits for the packet, wherein each element of the credit array corresponds to a destination among all the possible destinations from the neighboring routing component;
updating the prediction array by subtracting the credit array from the prediction array; and
determining that the updated prediction array is not empty, wherein the one or more remaining destinations are represented by the updated prediction array.

18. The media of claim 11, wherein reading without popping comprises:
setting a value of a shadow read pointer to a value of a read pointer of the FIFO queue;
repeatedly reading a chunk from the FIFO queue by incrementing the value of the shadow read pointer until the entire packet is read; and
rewinding the value of the shadow read pointer to the value of the read pointer.

19. The media of claim 11, transmitting the packet comprises modifying a field of the packet indicating destinations of the packet with information about the one or more destinations.

20. A computing system comprising:
one or more processors;
a routing component; and
one or more computer-readable non-transitory storage media coupled to the routing component and comprising instructions operable when executed by the routing component to cause the system to:
receive a packet to be forwarded to a neighboring routing component, wherein the packet is predicted to be further forwarded to a plurality of destinations from the neighboring routing component;
store the packet to a First-In-First-Out (FIFO) queue, wherein information regarding the plurality of destinations is stored on a prediction array associated with the packet;
determine, by using an arbiter associated with a transmission port connected to the neighboring routing component, to transmit the packet to the neighboring routing component for one or more destinations;
determine that the plurality of destinations comprise one or more remaining destinations in addition to the one or more destinations;
read without popping, in response to the determination, the packet from the FIFO queue; and
transmit the packet to the neighboring routing component through the transmission port.
